(19) United States
(12) Patent Application Publication
(10) Pub. No.: US 2013/0149197 A1
(43) Pub. Date: Jun. 13, 2013

(54) Biotechnology Detecting Device with Optical Fibers and LEDs

(71) Applicants: Shien-Kuei Liaw, Pingzhen City (TW); Chia-Ching Chang, Hsinchu City (TW); Shin-Hua Tseng, Zhudong Township (TW); Yi-Lin Yu, New Taipei City (TW); Shu-Chuan Lin, Taipei City (TW); Hung-Wei Chen, Gaoshu Township (TW)

(72) Inventors: Shien-Kuei Liaw, Pingzhen City (TW); Chia-Ching Chang, Hsinchu City (TW); Shin-Hua Tseng, Zhudong Township (TW); Yi-Lin Yu, New Taipei City (TW); Shu-Chuan Lin, Taipei City (TW); Hung-Wei Chen, Gaoshu Township (TW)

(73) Assignee: National Taiwan University of Science and Technology, Taipei City (TW)

(21) Appl. No.: 13/494,734

(22) Filed: Jun. 12, 2012

(30) Foreign Application Priority Data
Dec. 9, 2011 (TW) 100145657

(51) Int. Cl. G01N 21/64

(52) U.S. Cl. 422/82.08

(57) ABSTRACT

A biotechnology detection device with optical fibers comprises a first optical fiber connected to a light source, and a prism having a first surface and a second surface. The first surface is connected to the first optical fiber and coated with an anti-reflective layer to be passed through by short-wavelength light; a second optical fiber connected to the second surface of the prism. The end of the second optical fiber is to be coated with test sample blended with a fluorescent agent, wherein the fluorescent agent emits long-wavelength light after being excited by short-wavelength light. The second prism surface is coated with a high reflective layer to reflect part of the long-wavelength light. A third optical fiber is connected to the second prism surface to convey part of the long-wavelength light. A detector is connected to the third optical fiber for detecting part of the long-wavelength light.

### FIELD OF THE INVENTION

This invention is relative to a biotechnology detection device with Optical Fibers and LEDs.

### DESCRIPTION OF THE PRIOR ART

In a common hospital or clinic diagnosis can be executed after taking an X-ray photograph and sending the X-ray photograph to the doctor's computer. However, patient laboratory test samples may take several days or weeks to obtain the results. These laboratory samples include blood or urine for hepatitis, cholesterol, triglyceride, or other tests. Laboratory testing spent lot of precious diagnostic time.

Variable biotechnology detection devices have been developed to detect samples based on the changes of refractive index, using material attached on metal film, bonding, offset of resonant angle, or a change in the incident light resonant wavelength. All such instruments are designed according to the surface plasma resonance principle. Currently, the structures used to excite the surface plasma wave are comprised mainly of prism based surface plasma resonance, raster based surface plasma resonance, or optical waveguide based surface plasma resonance.

Optical fiber based surface plasma resonance technology aims mainly to shrink detectors to achieve miniaturization and portable advantages. The early optical fiber based detector was created by removing 10 mm cladding from a multi-mode optical fiber or plastic optical fiber and then plating a layer of silver film. Exciting the silver film create surface plasma resonance by an incident white light, used to detect sucrose with different refractive indexes for determining the linear relationship. This optical fiber based detector possesses simple functions, miniaturization and portable. Reflection based optical fiber detectors with gold nano particles bonded to the optical fiber surface improved multiple-function detection and improved the concentration detection accuracy.

However, reflection based optical fiber detectors have complicated processes, for example, a gold nano particle layer is plated onto the end of the optical fiber. A ligand layer is then formed onto the gold nano particle layer where the sample will be coated. These additional processes make manufacturing difficult and increase the cost. Therefore, the traditional biotechnology detection devices possess manufacturing drawbacks.

### SUMMARY OF THE INVENTION

In view of the above-mentioned issue, this invention provides an optical fiber based biotechnology detection device that employs a light emitting diode with a multi-mode optical fiber or plastic optical fiber to perform the examination.

This invention is designed to help hospitals or the clinics obtain testing results quickly to save hospital resources and diagnose/treat patients immediately.

A second purpose of this invention is to simplify optical fiber detector manufacturing to reduce the cost.

This invention provides a biotechnology detecting device with optical fibers comprising: a light source for emitting a short-wavelength light; a first optical fiber having a first end connected to the light source; a prism having a first surface and a second surface, wherein the first surface is connected to a second end of the first optical fiber and coated with a first antireflective layer to be passed through by the short-wavelength light; a second optical fiber having a first end connected to the second surface of the prism and a second end contacted with a sample blended with a fluorescent agent, wherein the fluorescent agent emits a long-wavelength light after being excited by the short-wavelength light, the long-wavelength light will be conveyed to the second surface of the prism along the second optical fiber, and the second surface is coated with a first high reflective layer to reflect a part of the long-wavelength light; a third optical fiber having a first end connected to the second surface of the prism to convey the part of the long-wavelength light; and a detector connected to a second end of the third optical fiber for detecting the part of the long-wavelength light to detect intermolecular interactions.

This invention provides a biotechnology detecting device with optical fibers comprising: a light source; a first optical fiber having a first end connected to the light source; a prism having a first surface and a second surface, wherein the first surface is connected to a second end of the first optical fiber and coated with a first antireflective layer which allows a light with any wavelength to pass through; a second optical fiber having a first end connected to the second surface of the prism and a second end smeared with a sample ; a mirror placed near the second end of the second optical fiber; a third optical fiber having a first end connected to the second surface of the prism, wherein the second surface is coated with a second high-reflective layer to reflect the light with any wavelength to the third optical fiber; and a detector connected to a second end of the third optical fiber for detecting signals transmitted by the light with any wavelength.

This invention provides a biotechnology detecting device with optical fibers comprising: a light source for providing a light; an optical fiber with a front end connected with the light source and a rear end smeared with a sample, wherein the light from the light source arrives the sample smeared on the rear end through the optical fiber; and a detector located outside the optical fiber for detecting a signal transmitted by the light passing through the sample and calculating concentration and properties of the sample. Based on the above-mentioned technologies, the invention can calculate the concentration and property of the sample on the basis of the change in signal from the sample. Lights of different wavelengths are used to examine different detection items. This invention can achieve the test results without a specific treatment on the optical fiber, thus solving the disadvantages of the traditional technologies. This invention employs a light emitting diode as the light source. An optional spherical lens can be mounted before the light emitting diode to increase the lighting efficiency. This invention uses less electricity than the traditional biotechnology detection device, which uses a laser as the light source.

The above-mentioned content is used to clarify the purposes of the present invention, the technical means to achieve these purposes, and the advantages resulting from the invention. The present invention can be understood based on the following preferred description embodiments, the accompanying drawings and the claims.

### BRIEF DESCRIPTION OF THE DRAWINGS

FIG. 1 illustrates a perspective view of an embodiment of the invention;

FIG. 2 illustrates a perspective view of another embodiment of the invention;

FIG. 3 illustrates a perspective view of a further embodiment of the invention; and

FIG. 4 shows the experimental results for embodiment of the invention.

### DESCRIPTION OF THE PREFERRED EMBODIMENT

Preferred embodiments and aspects of the invention will be described to explain the scope, structures and procedures of the invention. In addition to the preferred embodiments of the specification, the present invention can be widely applied in other embodiments.

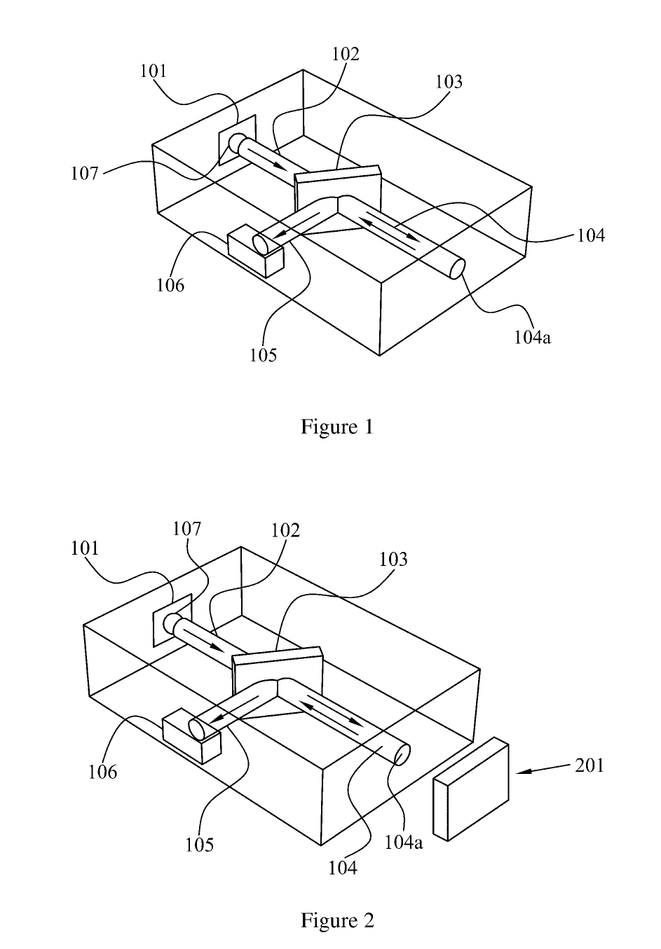

FIG. 1 illustrates an embodiment of the optical fiber based biotechnology detecting device of the invention. The biotechnology detecting device is comprised of a light source 101 for emitting a short-wavelength light, a first optical fiber 102 having a first end, a prism 103, a second optical fiber 104, a third optical fiber 105 and the detector 106. The light source 101 can be a light emitting diode to save the money. The first optical fiber 102 is connected to the light source 101. Alternatively, a spherical lens 107 can be mounted between the light source 101 and the first optical fiber 102 to increase the light source efficiency 101 radiating into the first optical fiber 102.

The prism 103 having a first surface and a second surface, wherein the first surface is connected to a second end of the first optical fiber 102, which is used to control the direction the light is conveyed. Specifically, the first surface of the prism 103, which faces the surface of the first optical fiber 102, can be coated with a first antireflective layer against the short-wavelength light to convey the short-wavelength light into the second optical fiber 104 without affecting the prism 103. The second optical fiber 104 has a first end connected to the second surface of the prism 103, and a second end contacted with a sample blended with a fluorescent agent. The short-wavelength light that passes through prism 103 can be conveyed by the second optical fiber. The end 104a of the second optical fiber 104 can be coated by the test sample, for example, blood, saliva, or urine. The sample can be mixed with a fluorescent agent.

After the sample absorbs the short-wavelength light, the fluorescent agent, which is excited, can be recovered to the stable energy lever and release the long-wavelength light. The released long-wavelength light radiates outwardly into the surrounding, but about 50% of the long-wavelength light will be conveyed back into prism 103 along the second optical fiber 104 because the fluorescent agent is coated onto the end 104a of the second optical fiber 104. The light in the optical fiber can only be conveyed forward or backward. The second prism 103 surface is coated by a high reflective layer against the long-wavelength light to reflect the long-wavelength light into the third optical fiber 105.

The third optical fiber 105 has a first end connected to the second surface of the prism 103 to convey the part of the long-wavelength light. The second optical fiber 104 forms a certain angle to reflect the long-wavelength light into the third optical fiber 105 by the high reflective layer of the second surface.

The detector 106 is connected to a second end of the third optical fiber 105 to receive the long-wavelength light from the third optical fiber 105, and detects the change in such signal to determine intermolecular interactions or the concentration or other sample property.

The first optical fiber 102, the second optical fiber 104, and the third optical fiber 105 are made of multi-mode optical fiber or plastic optical fiber and can convey back the light representative of the sample concentration without the complicated process. For example, the traditional optical fiber in commercialization provides the specification of 300 μm core diameter, 330 μm cladding thickness, 370 μm coating thickness and 400 db/km attenuation under 250 nm wave length light.

FIG. 2 illustrates another embodiment of the optical fiber based biotechnology detection device invention. As shown, the biotechnology detecting device is comprised of: a light source 101, a first optical fiber 102, a prism 103, a second optical fiber 104, a third optical fiber 105, and the detector 106. The difference from FIG. 1 is that the embodiment of FIG. 2 deploys a mirror 201 on the back of the end of the second optical fiber 104 to reflect the light rather than excites the fluorescent agent to radiate the long-wavelength light. How the embodiment of FIG. 2 works is described in the following. Firstly, the light from the light source 101 is conveyed to the prism 103 through the first optical fiber 102. Among them, the prism 103 can be coated with a second antireflective layer that allows light of any wave-length and does not have to filter out the short-wave-length light because there is no fluorescent agent coated onto the end 104a of the second optical fiber 104. After passing through the prism 103, the light can be conveyed through the second optical fiber 104 to its end 104a, which can be coated by the sample. Because the light is partially absorbed by the sample, and thus the sample concentration will affect the degree the light is absorbed. The remaining light continues to proceed to the mirror 201 in the rear and is reflected by the mirror 201. The second surface of the prism 103 can be plated by the high reflective layer that can reflect the light of any wave-length to reflect the light to the third optical fiber 105, and the third optical fiber 105 conveys the light to the end of the detector 106 to examine the change of the signals and get the concentration of the sample. Concerning the material of the first optical fiber 102, the second optical fiber 104 and the third optical fiber 105, the multimode optical fiber or the plastic optical fiber are preferred but not limited to. For example, the traditional commercial optical fiber in provides a 300 μm core diameter, 330 μm cladding thickness, 370 μm coating thickness, and 400 dB/km attenuation under 250 nm wave-length light specification.

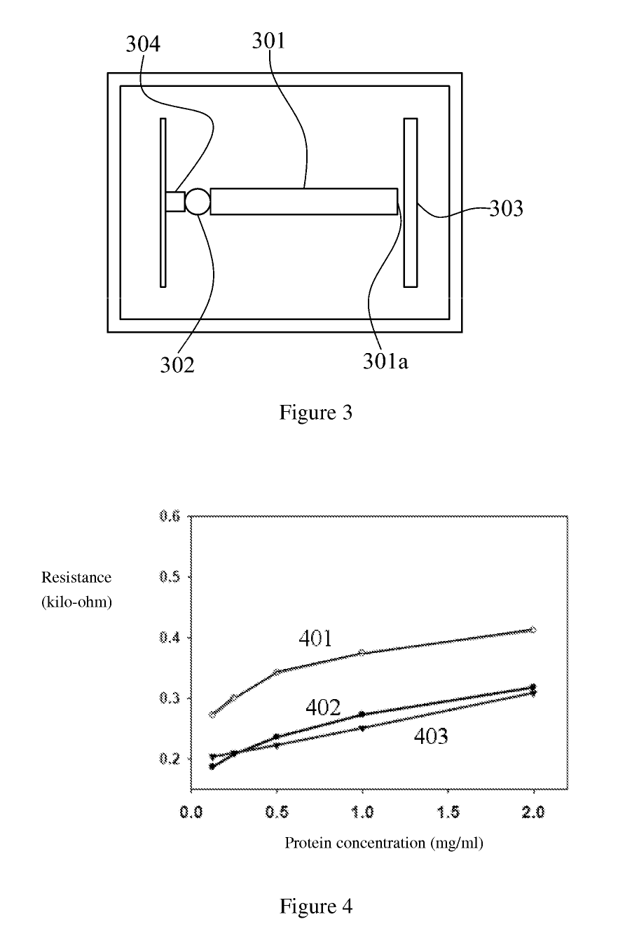

FIG. 3 illustrates another embodiment of the optical fiber based biotechnology detection device invention. As shown, the biotechnology detection device is mainly comprised of: a light source 304 for emitting a light; an optical fiber 301 whose front end is connected to the light source 304 and whose rear end is used to coated a sample, wherein the light from the light source 304 passes through the optical fiber 301 and reaches the sample in the rear end of the optical fiber 301; and a detector 303 outside the rear end of optical fiber 301 to detect a signal of the light passing through the sample, and calculate the concentration and property of the sample on the basis of the change in the signal.

Among them, the light source 304 is preferred to be a light emitting diode and a spherical lens 302 mounted between the light source 304 and the optical fiber 301 to increase the coupling efficiency that the light emitting diode radiates into the optical fiber 301. Optical fiber 301 is preferred as the multi-mode optical fiber or plastic optical fiber. The user can coat a sample onto the end 301a of the optical fiber 301. The light conveyed through the optical fiber 301 to the detector 303, is affected by the sample concentration, allowing the detector 303 to determine the sample concentration or other property based on the change in the signal. This invention provides a mechanism that needs neither optical fiber processing nor a prism supplement or splitter to detect the biological sample using a simple light structure, thus reducing the manufacturing cost.

The biotechnology detecting device in FIGS. 1, 2 and 3 are not limited to a rectangular shape and can be elliptical or other shapes.

FIG. 4 illustrates the experimental result from the embodiment in FIG. 3, where the sample is a protein. The abscissa represents the protein concentration in mg/ml units. The longitudinal axis represents the resistance in kilo-ohm units. This experiment adopts a white, red and blue light emitting diode to perform the test. Curve 401 shows the detection result from the red light emitting diode. Curve 402 shows the detection result from the white light emitting diode. Curve 403 shows the detection result from the blue light emitting diode. As shown, the protein concentration is proportional to the resistance and thus this invention can accurately calculate the sample concentration based on the measured resistance, which is relative to the wavelength of the light emitting diode.

The above context is the preferred embodiment of the present invention. Skilled persons in the art should be able to understand that the specification is used to illustrate the invention rather than limit the scope of the invention. The scope of claims should be defined by the following claims and their equivalents. Skilled persons in the art can change or modify the technique context recited in the specification to achieve the equivalent designation or modification, which should be read in the following claims, without departing from the spirit or scope of the invention.

What is claimed is:

1. A biotechnology detecting device with optical fibers comprising:
a light source for emitting a short-wavelength light;
a first optical fiber having a first end connected to the light source;
a prism having a first surface and a second surface, wherein the first surface is connected to a second end of the first optical fiber and coated with a first antireflective layer to be passed through by the short-wavelength light;
a second optical fiber having a first end connected to the second surface of the prism and a second end contacted with a sample blended with a fluorescent agent, wherein the fluorescent agent emits a long-wavelength light after being excited by the short-wavelength light, the long-wavelength light will be conveyed to the second surface of the prism along the second optical fiber, and the second surface is coated with a first high reflective layer to reflect a part of the long-wavelength light;
a third optical fiber having a first end connected to the second surface of the prism to convey the part of the long-wavelength light; and
a detector connected to a second end of the third optical fiber for detecting the part of the long-wavelength light to detect intermolecular interactions.

2. The biotechnology detecting device of claim 1, wherein the light source is a light emitting diode.

3. The biotechnology detecting device of claim 2, further comprising a spherical lens mounted between the light emitting diode and the first optical fiber. to

4. The biotechnology detecting device of claim 1, wherein the first optical fiber, the second optical fiber, and the third optical fiber are multimode optical fibers.

5. A biotechnology detecting device with optical fibers comprising:
a light source;
a first optical fiber having a first end connected to the light source;
a prism having a first surface and a second surface, wherein the first surface is connected to a second end of the first optical fiber and coated with a first antireflective layer which allows a light with any wavelength to pass through;
a second optical fiber having a first end connected to the second surface of the prism and a second end smeared with a sample ;
a mirror placed near the second end of the second optical fiber;
a third optical fiber having a first end connected to the second surface of the prism, wherein the second surface is coated with a second high-reflective layer to reflect the light with any wavelength to the third optical fiber; and
a detector connected to a second end of the third optical fiber for detecting signals transmitted by the light with any wavelength.

6. The biotechnology detecting device of claim 5, wherein the light source is a light emitting diode.

7. The biotechnology detecting device of claim 6, further comprising a spherical lens mounted between the light emitting diode and the first optical fiber.

8. The biotechnology detecting device of claim 5, wherein the first optical fiber, the second optical fiber, and the third optical fiber are multimode optical fibers.

9. A biotechnology detecting device with optical fibers comprising:
a light source for providing a light;
an optical fiber with a front end connected with the light source and a rear end smeared with a sample, wherein the light from the light source arrives the sample smeared on the rear end through the optical fiber; and
a detector located outside the optical fiber for detecting a signal transmitted by the light passing through the sample and calculating concentration and properties of the sample.

10. The biotechnology detecting device of claim 9, wherein the light source is a light emitting diode.

11. The biotechnology detecting device of claim 10, further comprising a spherical lens mounted between the light emitting diode and the optical fiber.

12. The biotechnology detecting device of claim 9, wherein the optical fiber is a multimode optical fiber or a plastic optical fiber.

13. The biotechnology detecting device of claim 9, wherein the biotechnology detecting device is with elliptical or other shapes.
